(19) United States
(12) Patent Application Publication
(10) Pub. No.: US 2008/0276008 A1
(43) Pub. Date: Nov. 6, 2008

(54) Secure and Accurate Method for Processing Prescriptions

(76) Inventor: Mauricio A. Leon, San Diego, CA (US)

Correspondence Address: Mauricio A. Leon, 9658 Deer Trail Way, San Diego, CA, 92127, US

(21) Appl. No.: 11/834,409

(22) Filed: Aug. 6, 2007

Related U.S. Application Data
(60) Provisional application No. 60/915,435, filed on May 2, 2007.

(51) Int. Cl. G06F 3/01; G06K 9/03; G06Q 50/00; H04N 1/04

(52) U.S. Cl. 710/1; 358/474; 382/112; 705/2

(57) ABSTRACT

The present invention is a new method of processing a prescription that has advantages of security and accuracy while preserving convenience of older methods. The new method includes (1) receiving image information defining an image of a hard copy prescription, (2) displaying the image upon a user interface, (3) receiving response information from the user interface indicative of whether the image is acceptable, and (4) storing the image information on a secure system.

### RELATED APPLICATIONS

This non-provisional application claims priority to U.S. Provisional Application Ser. No. 60/915435, Entitled “Method for Transmitting Medical Orders for Prescriptions, Medical Products, or Services” by Mauricio Leon, filed on May 2, 2007, incorporated herein by reference under the benefit of U.S.C. 119(e).

### FIELD OF THE INVENTION

The field of the invention concerns methods for processing medical prescriptions. More particularly, the present invention concerns a way of processing a prescription that has advantages of security and accuracy while also preserving the convenience and simplicity of older procedures.

### BACKGROUND

Prescriptions for medical devices, services, and medications are generally prescribed by health care providers such as physicians and then filled by pharmacies. Historically nearly all prescriptions were hand written and most were hand-carried by patients to pharmacies. For the convenience of the patient, hand written or hard copy prescriptions have more recently been sent to pharmacies by facsimile.

Problems with hand written prescriptions are generally known. A physician's hand writing may be difficult to read leading to potential interpretation error at the pharmacy. With the onset of the facsimile, while providing convenience for the patient, potential for error and omission has increased. Facsimile-sent documents suffer from degradation and sometimes complete loss in image quality at each end of the transmission resulting in an increase in error and omission rate. There are also issues with lack of traceability and with security with facsimile sent documents.

Solutions have been attempted such as eliminating hand written prescriptions using direct electronic input with desktop, laptop, or palm top computers. Such solutions have implementation hurdles including cost, software incompatibilities, and the need for medical personnel to learn a new system. As a result implementation has not been widespread. What is needed is a system that preserves the simplicity and conveniences of existing hand written or hard copy prescription procedures but overcomes aforementioned issues of security, error and omission.

### BRIEF DESCRIPTION OF THE DRAWINGS

FIG. 1 is a block diagram representation of an information technology system incorporating the present invention.

FIG. 2 is a flow chart representation of a method of the present invention.

FIG. 3A is a flow chart representation of a method of the present invention.

FIG. 3B is a flow chart representation of a method of the present invention.

FIG. 4 depicts an image viewed on a provider or patient user interface that includes instructions and buttons for initiating scanning of a hand written or hard copy prescription.

FIG. 5 depicts an image viewed on a provider or patient user interface that includes an image of a hand-written prescription.

FIG. 6 depicts an image viewed on a provider user interface that includes a request from a pharmacy for clarification of an image of a hand written or hard copy prescription.

FIG. 7 depicts an image viewed on a provider user interface including annotation information to be provided in response to a request from a pharmacy.

### DESCRIPTION OF EXEMPLARY EMBODIMENTS

The present invention concerns a system for filling prescriptions that provides much compatibility with existing processes while providing advantages of sophisticated IT (information technology) systems. The present invention allows a doctor to continue to write or print prescriptions on hard copy media and yet provides the accuracy, security, and lack of omission provided by reliable IT system. Hard copy media includes paper or other media suitable for hand writing or printing or word processors. A “hard copy prescription” refers to a prescription that is hand written or printed onto hard copy media.

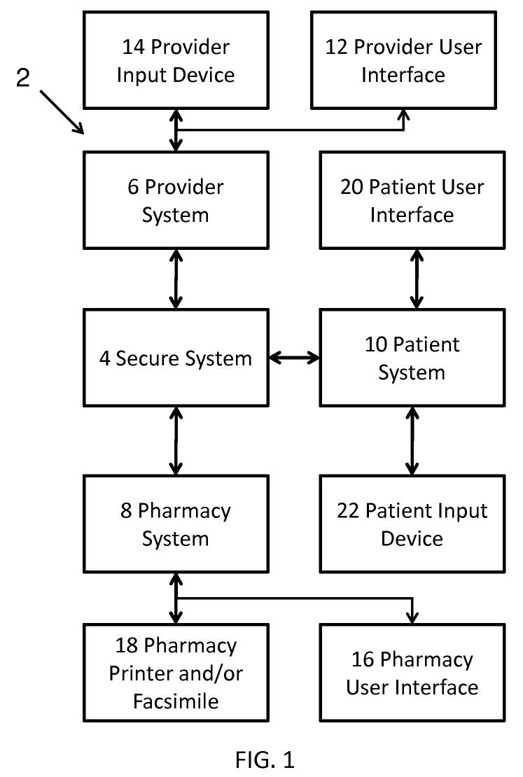

An IT system 2 of the present invention is depicted in block diagram form in FIG. 1. IT system 2 includes: secure (IT) system 4 coupled to a provider system 6, a pharmacy system 8, and a patient system 10 via a network such as the internet.

In one embodiment, secure system 4 is a secure IT system including a secure server and a secure mass storage system (not shown). Secure system 4 is preferably locked in a secure and guarded facility that rigorously prevents unauthorized access to secure system 4.

Provider system 6 is an IT system utilized by a health care provider such as a physician, a clinic, or a hospital. Provider system 6 is coupled to a user interface 12 and an input device 14. User interface 12 may include a visual display and a keyboard (not shown). Input device 14 is configured to enable a hand written prescription to be digitized or otherwise converted to an image of the hand written prescription that can be transmitted to secure system 4. In one embodiment, input device 14 is a scanner that is either a stand-alone scanner or is integrated into a multifunction printer or other device.

Pharmacy system 8 is an IT system utilized by a pharmacy such as a drug store, a pharmacy built into a grocery store, a pharmacy built into a discount retailer, or an “e-pharmacy” that is an internet based pharmacy. Pharmacy system 8 is coupled to a user interface 16 and an output device 18 such as a printer, facsimile, or a multifunction device.

Patient system 10 is an IT system utilized by a patient and may consist of a personal computer, a laptop, or a hand held computing device such as a cellular phone or palm top computer. Patient system 10 is coupled to a user interface 20 and an input device 22. User interface 12 may include a visual display and a keyboard (not shown). User interface 20 and input device 22 are similar to elements 12 and 14 discussed with respect to the provider system 6.

Secure system 4 is configured to receive image information defining an image of a hand written or hard copy prescription that originates from input device 14 or 22. Secure system 4 is configured to display the image upon user interface 12, 16, or 20. In one embodiment, the image is displayed within a graphical user interface. Secure system 4 is configured to receive response information from user interface 12, 16, or 20 that is indicative of whether the image is acceptable.

If the image information is not acceptable, secure system 4 is configured to receive image update information from user interface 12 or 20. In a first embodiment, the update information includes replacement image information from input device 14 or 22. In a second embodiment, the image update information includes annotation information from provider user interface 14.

Once the image is acceptable, the secure system 4 is configured to store the image information and to make the image information available for further processing by pharmacy system 8 and/or patient system 10.

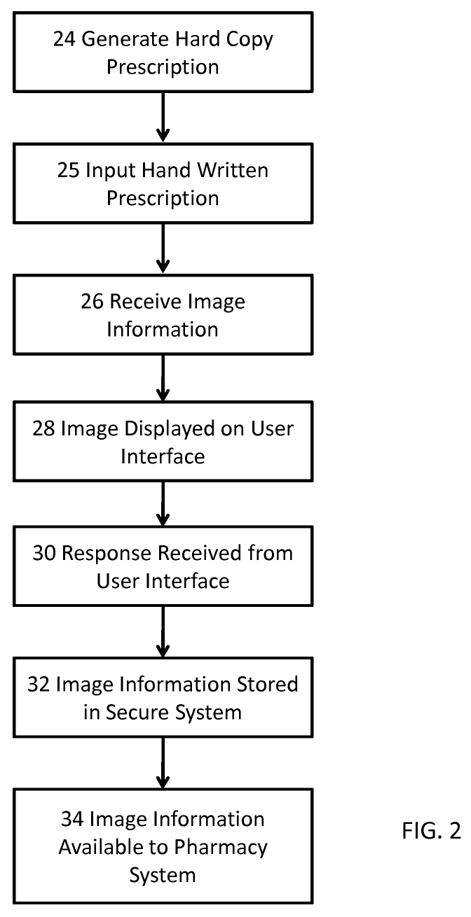

An exemplary method of the present invention is depicted in flow chart form in FIG. 2. According to 24, a hand written or hard copy prescription is provided by a medical practitioner. According to 25, the hand written or hard copy prescription is input to an input device such as the provider input device 14 or the patient input device 22.

According to 26, image information defining an image of the prescription resultant from 24 is received by secure system 4 from the input device. According to 28, the image of the prescription is displayed upon a user interface. The user interface may be the provider user interface 12, the pharmacy user interface 16, or the patient user interface 20. At this point, a user of the user interface reviews the image of the prescription.

According to 30, response information is received from the user interface (12, 16, or 20) by secure system 4. In a preferred embodiment, the response information is indicative of whether the image is acceptable. In one embodiment, the response information includes an indication to submit the image information for further processing. In another embodiment, the response information includes a request that is indicative of a need to clarify the image.

According to 32, the image information is stored in the secure system 4. According to 34, access is provided to a system such as a pharmacy system 8 for further processing and/or filling prescription orders pursuant to the prescription.

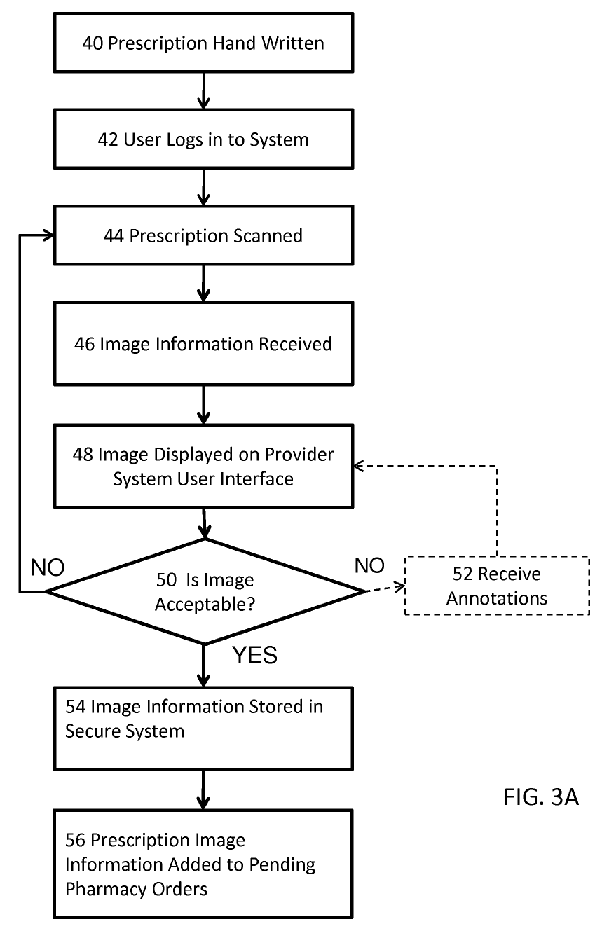

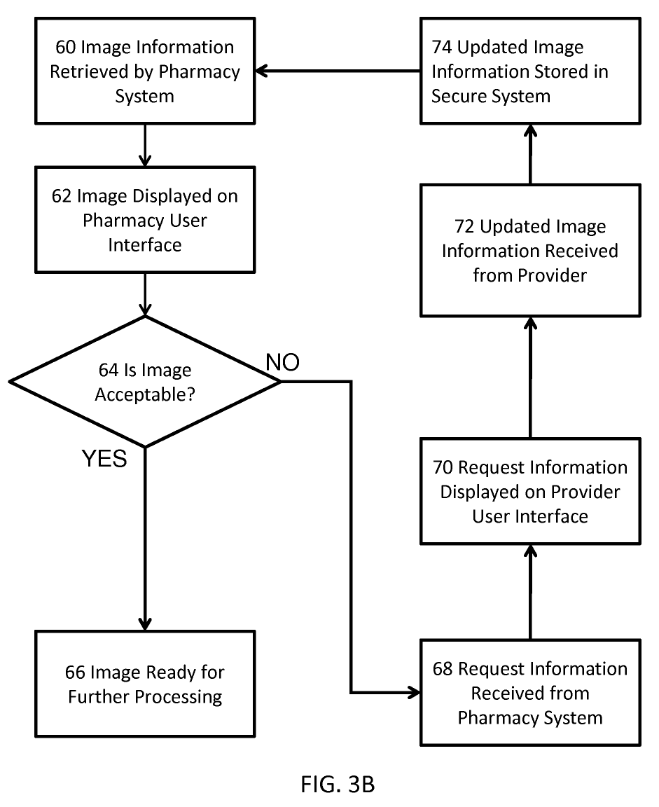

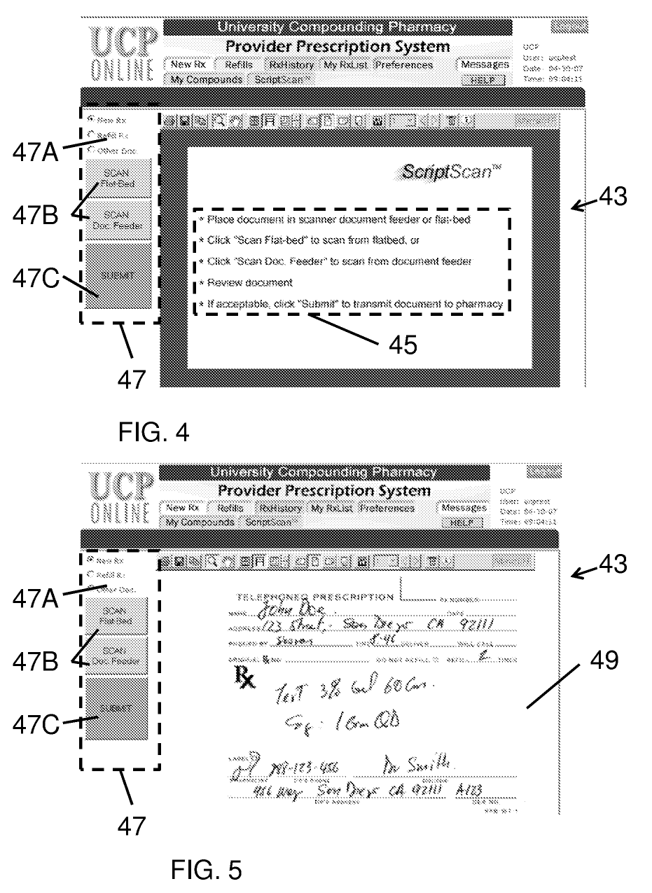

FIGS. 3A and 3B depict preferred methods of the present invention applied to a health care provider or a pharmacy, respectively. FIGS. 4-7 are exemplary “screen shots” or images that may be displayed upon a user interface. The discussion for FIGS. 3A and 3B will sometimes refer to FIGS. 4-7 to illustrate certain steps.

FIG. 3A depicts a preferred method of the present invention in flow chart form. According to 40, a practitioner produces a hand written or hard copy prescription. The hand written or hard copy prescription is provided to a user (who may be a nurse, clerk, or the practitioner who wrote the prescription). Alternatively, the user could be a patient who has a home computer system (patient system 10).

According to 42, the user logs into IT system 2. In one embodiment, step 42 is a “one click” log in wherein clicking on an icon launches a software application that enables use of the present invention. In one embodiment, a GUI 43 (graphical user interface) similar to the image depicted in FIG. 4 is generated upon the provider user interface 12 in response to step 42. GUI 43 includes on-screen instructions 45, and input buttons 47.

On screen instructions 45 indicate the steps that the user can take to input the hand written or hard copy prescription in order to generate image information that can be utilized by secure system 4. These instructions include (1) placing the hand written or hard copy prescription (document) onto the scanner 14 or 22, (2) activating a SCAN button 47B from among input buttons 47, (3) reviewing the document for acceptability, and (4) activating a SUBMIT button 47C from among the input buttons 47.

The input buttons 47 enable the user to input response information to the IT system 2. Input buttons 47 depicted in FIG. 4 include selection buttons 47A, SCAN buttons 47B, and a SUBMIT button 47C. Of course, other input buttons are possible and it is to be understood that FIG. 4 is exemplary.

Referring back to FIG. 3A, the user inputs the hand written or hard copy prescription into an input device 14 or 22 according to 44. According to the example depicted in FIG. 4 this is accomplished by placing the hand written or hard copy prescription into a scanner 14 or 22 and then activating a SCAN button 47B from among input buttons 47.

According to 46 of FIG. 3A, the hand written or hard copy prescription has been scanned by provider input device 14 and information indicative of an image of the prescription has been received by secure system 4. According to 48, the image is displayed upon user interface 12 or 20. FIG. 5 depicts image 49 of a hand written or hard copy prescription displayed upon GUI 43. According to decision step 50, the user then reviews the image to see if it is acceptable. The user then provides response information to IT system 2 via the user interface 12 or 20. The response may indicate that the image is acceptable or not acceptable.

If the image is not acceptable, the user may then rescan the hand written or hard copy prescription according to 44. According to 46, replacement image information is generated in response to the rescanning of step 44. According to 48, a replacement image is displayed upon the user interface (12 or 20) that is defined by the replacement image information. Once again, the user reviews the image to decide whether it is acceptable according to 50.

If according to 50, the image is acceptable, the user may then provide an input to the user interface (12 or 20) that is indicative of an acceptance of the image. For the exemplary interface of FIG. 5, this is accomplished when the user activates a SUBMIT button 47C from among input buttons 47.

After the image information is submitted according to 50, it is stored in secure system 4 according to 54. According to 56, the image information is added to information defining pending orders for a pharmacy system 8.

Referring back to FIG. 3A, an alternative process applying only to providers may be used according to 52. According to 50, if the image is not acceptable, the user may provide annotations to the prescription according to 52. The annotations are then added to the image information and the image is redisplayed with annotation information according to 48.

FIG. 3B depicts a preferred method of the present invention in flow chart form. Pursuant to the method of FIG. 3B, information defining images of hand written or hard copy prescriptions are stored on secure system 4 and are available for further processing by pharmacy system 8.

According to 60, pharmacy system 8 receives image information defining an image of a hand written or hard copy prescription from secure system 4. In one embodiment, the image information is a result of the method depicted in FIG. 3A. According to 62, the image is displayed upon pharmacy user interface 16. In an alternative embodiment of 62, a printed version of the image is generated by pharmacy device 18.

According to 64, a user at a pharmacy reviews the image. According to 66 or 68, secure system 2 receives a response indicative of whether the image is acceptable. If the image is acceptable, the image is then ready for further processing as indicated by 66.

On the other hand, if the image is not acceptable, the pharmacy provides request information to secure system 4 indicative of a need to clarify the image according to 68. The request information may be in the form of text message or a “marked up” or annotated version of the image of the prescription.

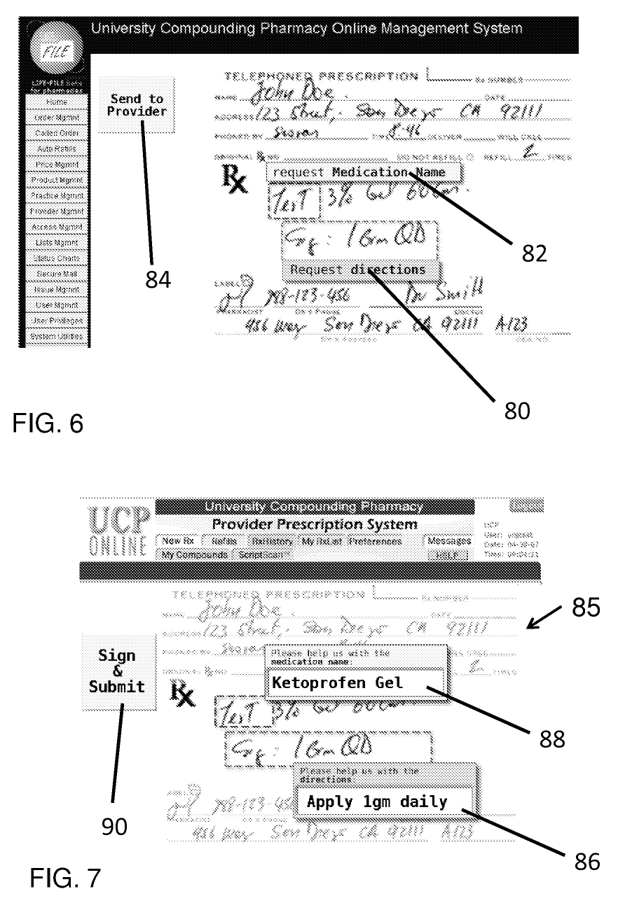

One example of request information is depicted in FIG. 6 wherein an image is sent that has text boxes 80 and 82 that indicate information needed to clarify the image of the prescription. Also depicted in FIG. 6 is an input button 84 that enables the pharmacy to send the request for further information to the provider system 6.

When the input button 84 is activated, the request information is routed to secure system 4 according to 68 and then to provider system 6 according to 70. In one embodiment a GUI 85 similar to that depicted in FIG. 7 is displayed upon provider user interface 12. GUI 85 includes text boxes 86 and 88 for receiving annotation information that can be inputted using provider user interface 12. Once the information is inputted to text boxes 86 and 88, a “Sign and Submit” button 90 may be activated.

According to 72, secure system receives clarifying information or updated image information from the provider system 6 in response to the activation of button 90. The updated image information is then stored in the secure system 4 according to 74.

The process can then start again according to 60 wherein the image information of step 60 is now the updated image information. In one embodiment, the image information defines annotations or text boxes such as elements 86 and 88 depicted in FIG. 7.

The method of the present invention preserves manual hand written or hard copy prescription procedures utilized by medical practitioners and pharmacists today while providing advantages of data integrity, security, and rapid generation of prescriptions. The present invention also provides feedback to users of IT system 2 so that they have better confidence that complete and accurate prescription orders are being processed.

The foregoing disclosure and description of the invention is illustrative and explanatory thereof. Various changes in the details of the illustrated construction may be made within the scope of the appended claims without departing from the spirit of the invention.

What is claimed is:

1. A method of processing a prescription comprising:
receiving image information defining an image of a hand written prescription;
displaying the image upon a user interface;
receiving response information from the user interface indicative of whether the image is acceptable; and
storing the image information on a secure system.

2. The method of claim 1 wherein the response information indicates that the image is not acceptable, and further comprising:
receiving image update information that defines a corrected image of the hand written prescription; and
storing the image update information on the secure system.

3. The method of claim 1 wherein the response information indicates that the image is not acceptable, and further comprising:
receiving replacement image information that defines a replacement image of the hand written prescription; and
storing the replacement image information on the secure system.

4. The method of claim 1 wherein the response information indicates that the image is not acceptable and further comprising:
receiving annotation information that clarifies the image; and
storing the annotation information on the secure system.

5. The method of claim 1 wherein the response information is request information indicative of a need to clarify the image.

6. The method of claim 5 wherein the request information is received from a pharmacy system and further comprising:
transferring the request information to a provider system; and
receiving clarifying information from the provider system.

7. The method of claim 6 wherein the clarifying information includes annotations for the image information, and further comprising:
defining updated image information based upon the image information and the clarifying information; and
storing the updated image information on the secure system.

8. The method of claim 1 further comprising inputting the image information to one of a plurality of pending pharmacy orders.

9. The method of claim 1 wherein the user interface is one of a provider system user interface, a pharmacy system user interface, or a patient system user interface.

10. A system for processing a prescription comprising a secure system coupled to a network and configured to:
receive image information from a provider system, the image information defining an image of a hard copy prescription;
display the image upon a user interface;
receive response information indicative of whether the image is acceptable;
and
store the image information for further processing.

11. The method of claim 1 wherein the response information indicates that the image is not acceptable and wherein the secure system is further configured to receive replacement image information from the provider system, the replacement image information defining a replacement image of the hard copy prescription.

12. The method of claim 1 wherein the response information includes request information indicative of a need to clarify the image.

13. The method of claim 12 wherein in the secure system is configured to receive annotation information from the provider system that clarifies the image.

14. The method of claim 13 wherein the secure system is configured to store updated image information based upon the image information and the annotation information.

15. A method of delivering a prescription comprising:
receiving a scan activation at a computer user interface;
scanning a hard copy prescription in response to the scan activation;
generating image information in response to the scanning;
generating an image defined by the image information on the user interface; and
receiving a response from the user interface that defines further processing of the image.

16. The method of claim 15 wherein the response is indicative of whether the image is acceptable.

17. The method of claim 16 wherein the response indicates that the image is not acceptable and further comprising receiving image update information that defines a corrected image of the hard copy prescription.

18. The method of claim 17 wherein the image update information is one of: (1) a replacement image resulting from rescanning the hard copy prescription or (2) annotation information that clarifies the image.

19. The method of claim 15 further comprising:
transferring the image information to a secure system; and
enabling a pharmacy system to have access to the image information.

20. The method of claim 19 further comprising:
receiving request information from the pharmacy system indicative of a need to clarify the image; and
receiving updated image information from a provider system.
